(19) United States
(12) Patent Application Publication
(10) Pub. No.: US 2010/0037294 A1
(43) Pub. Date: Feb. 11, 2010

(54) METHOD AND APPARATUS FOR PROVIDING A HIERARCHICHAL SECURITY PROFILE OBJECT

(76) Inventor: Taylor W. Kidd, Redwood City, CA (US)

Correspondence Address: OPTV/MEYERTONS, MEYERTONS, HOOD, KIVLIN, KOWERT & GOETZEL, P.C., P.O. BOX 398, AUSTIN, TX, 78767-0398, US

(21) Appl. No.: 12/603,323

(22) Filed: Oct. 21, 2009

Related U.S. Application Data
(63) Continuation of application No. 10/375,860, filed on Feb. 27, 2003.
(60) Provisional application No. 60/360,100, filed on Feb. 27, 2002.

(51) Int. Cl. H04L 9/00; H04N 7/167

(52) U.S. Cl. 726/2; 380/211

(57) ABSTRACT

A hierarchical security policy that can be imposed by a policy maker upon a class of entities in an interactive television environment. A general policy is defined for a class of entities. A specific policy may also be defined for any subclass of entities, such as the grouping of advertisements or programs. A specific policy may be defined for any given entity, such as a specific television program as an exception to a class.

### CROSS REFERENCE TO RELATED APPLICATIONS

This application claims benefit of priority to Provisional Application Ser. No. 60/360,100 filed Feb. 27, 2002.

### COPYRIGHT NOTICE

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2002 OpenTV, Inc.

### BACKGROUND OF THE INVENTION

1. Field of the Invention

This invention relates to security in interactive television and, more particularly, to hierarchical security profile management for programs, services and other applications transmitted in an interactive television environment.

2. Description of the Related Art

The latest forms of television broadcast communication include the possibility of interactive television in which not only does the broadcaster send its programs to the viewer, but the viewer may also send information back to the broadcast source or emitter. Content from the broadcaster typically includes network programs and commercials, as well as web pages, interactive televised programs, graphics and text, and other items. Without restriction, the viewer at the same time may request information from the broadcaster or send data via the television device. Users or viewers may interact with the systems in various ways including, for example, ordering advertised products or services, chatting with other viewers, requesting specialized information regarding particular programs, or navigating through pages of information.

Generally speaking, at one end of this broadcast communication stream is a client integrated receiver/decoder (IRD), such as a set-top box (STB), which receives the transmitted content from a server or head-end. The head-end, generally a network operator in an interactive television environment, collects the signals from various networks (e.g. CNN, ESPN, etc.) and transmits them to its clients (e.g. STBs) along with a variety of additional content including E-Commerce services and interactive programs. The STB connects to the television set and typically sits on top of it. This IRD operates computer programs referred to herein as middleware which controls the flow of transmitted programs, interactive programs and internet traffic transmitted from the server head-end as well as data sent/received by the viewer to the head-end via the IRD. The IRD is generally configured to handle the bi-directional flow of data. In an interactive environment some programs provide for strictly one-way communications, other programs provide for two-way communications, and still other programs provide optional modular programs through which the viewer might gain further information on a point of interest. Due to the integration of many different media formats, the IRD may also be able to recognize the different media formats of the content, such as the difference between the form and protocol of a web page, and that of a television commercial.

Furthermore, due to the fact that each type of communication for each program has its own level of interaction and/or its own protocol, it may be desirable to require a particular level of security in order to identify the allowed level of interaction for a program and maintain the integrity of the communication. Due to the interactive nature of the medium, it is desirable to define a security policy to regulate the type of access available to a viewer and the level at which viewer programs running on the IRD may interact with other entities, such as the head-end server, and other clients and with each other.

In the past, either the security policy was fixed, i.e., hardwired into the IRD, or the head-end server formulated and provided a security policy for controlling the access of programs (e.g. such as an XML declaration in a file associated with each program downloaded from the server to the client IRD). The security policy relating to programs running on the IRD was typically defined by a policy maker. A Security Manager, a program running on the IRD, then moderated the services that the IRD performed relative to the provided security policy.

Several security policies paradigms exist in prior art. One example of such a paradigm, the JAVA TV API, includes the JAVA 2 Platform Security Architecture, which defines a framework consisting of security related APIs for enforcing a security policy in a JAVA execution environment. The JAVA TV API does not dictate a particular security model or policy, but uses the JAVA development Kit (JDK) 1.2 security architecture to express the security policies that are provided by the application environment. This solution provides architects, such as network operators and standards organizations, the freedom to redefine their security models as future needs change. The JAVA 2 Platform Security Architecture does not mandate a format for the Security Policy though it does provide an example/default implementation. This example implementation provides a system-wide security policy and a user-specific policy file. In the digital television environment, Digital Video Broadcasting's (DVB's) Multimedia Home Platform (MHP) and the Advanced Television Systems Committee's (ATSC) Digital Television Application Software Environment (DASE) are both based on JAVA TV technology.

Another example of a prior art security policy implementation paradigm may be found in the Multimedia Home Platform (MHP) 1.0 and 1.1 specifications (which are specific instantiations of the JAVA 2 Platform Security Architecture discussed above). The resource access policy for MHP is derived from the access rights requested by the broadcaster or head-end and access rights granted by the user. This method defines a format for a security policy on a per application basis via a “permission request file”. The permission request file defines those resources that the associated application can access.

Yet another method for designating security permissions is the Digital TV Application Software Environment (DASE). The DASE Level 1 draft specification defines two policy files, one being a broadcaster's permissions file and the other applying specifically to the individual applications. The broadcaster permissions file applies to all downloaded applications executed and typically defines those operations the broadcaster will permit an application to execute. The application's permission file defines specifically which resources to which an application can request access. The actual security policy implemented by the IRD is the intersection of the broadcaster and application's permission files. The overall security profile consists of the broadcaster's policy and of the specific policy associated with the application. This approach provides a two-level security implementation wherein both files are transmitted and are specifically associated with each individual application or program by the Security Manager.

In the interactive television environment, communication bandwidth and processing capability are limited in the typical client. In addition, there are numerous different types of applications, each of these types potentially requiring their own distinct set of security permissions. Thus, there is a need for an efficient and flexible method and apparatus for implementing a security policy that enables customized security policies for different applications.

### SUMMARY OF THE INVENTION

A broadcaster security policy that may be imposed by a policy maker upon a class of entities in an interactive television environment is disclosed. A general policy is defined for a class of entities. A specific policy may also be defined for any subclass of entities, such as the grouping of advertisements or programs. A specific policy may be defined for any given entity, such as a specific television program as an exception to a class. Thus, the hierarchical security program object described herein may be more efficient and more general than known security specifications which define security and security permissions separately in a file provided along with each individual application.

### BRIEF DESCRIPTION OF THE DRAWINGS

FIG. 1 is a diagram illustrating one embodiment of the distribution of interactive television applications, television programs, and system information from a head-end source server to a client.

FIG. 2 illustrates one embodiment of a service platform head-end server and client communication.

FIG. 3 is a diagram illustrating one embodiment a hierarchical security profile object.

FIG. 4 illustrates one embodiment of a security policy as applied to an application.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

In a typical program structure for interactive television, the presentation of network programs and interactive applications and events are controlled by computer. Television shows and advertisements are specific instances of data and computer applications. The television shows themselves are typically encoded in MPEG format. In addition, the broadcaster may also insert computer programs into the transmitted stream for download to the client IRD through which the viewer may interact with the application and/or make viewing decisions. Given that the client IRD may execute a transmitted program, the network must consider the risk of sabotage and both intentional and unintentional mischief. It is necessary to be careful not to inadvertently transmit or enable transmission of either a TV or computer virus. Each inserted program or application has different levels of required or permissible interaction with the viewer and the hosting client (i.e. IRD). It is generally preferable to disable capabilities that may be not needed or desired during an application's execution, but which, if otherwise allowed could be disruptive to communications or to the integrity of the operating environment and data at both the head-end server and/or the client.

In one embodiment, a server transmits the security restrictions or permissions to a receiver client (e.g. STB) that the server wishes to impose on the client by transmitting a hierarchical security policy object (HSPO) to the client. The HSPO provides a security inheritance structure. In one embodiment, the HSPO may be one object (e.g. a single file) but may alternatively be distributed across many such objects. In one embodiment, the HSPO may be organized as a tree with one root. The root of the HSPO tree contains the most general and universal security restrictions and exceptions such as the security restrictions for the head-end which are enforced on all networks and content transmitted by the server, for example. Successive nodes branching off of the HSPO root contain more specific security requirements, the level of specificity increasing with the increasing distance or “order” of the nodes away from the root.

Each node of the HSPO tree represents a class or subclass of applications and the additional restrictions, or additional privileges, which the client receiver is to impose or grant to entities such as applications in the corresponding class or subclass. The final set of restrictions/privileges that is imposed/granted to a given application are derived (typically by a security manager with a receiving IRD) from this HSPO by following a defined procedure for combining the appropriate nodes of the HSPO tree along with any additional restrictions imposed by the client (i.e. IRD). Thus, an application inherits the security attributes of the class to which it belongs and all the security attributes of predecessor nodes in the HSPO tree. For example, in one embodiment, the lowest node in the tree corresponding to the application is identified and a union of all the restrictions/privileges of this node's ancestor nodes is performed. This structure may prove efficient in that the implementation of a new application, by design, requires the specification of a smaller set of security requirements at the time of implementation. That is, only exceptions to the existing security policy need be specified for a group of applications or an individual application. Accordingly, arbitrary types of applications may have a uniform set of security requirements automatically imposed.

Nodes branching off of the HSPO root node may represent a network or a class of applications, such as advertisements or network programs, and nodes subordinate to these nodes segment these security classes into further subclasses. Generally, the security level at one class level is more or less restrictive than its parent class. Security levels can also vary at the same class level.

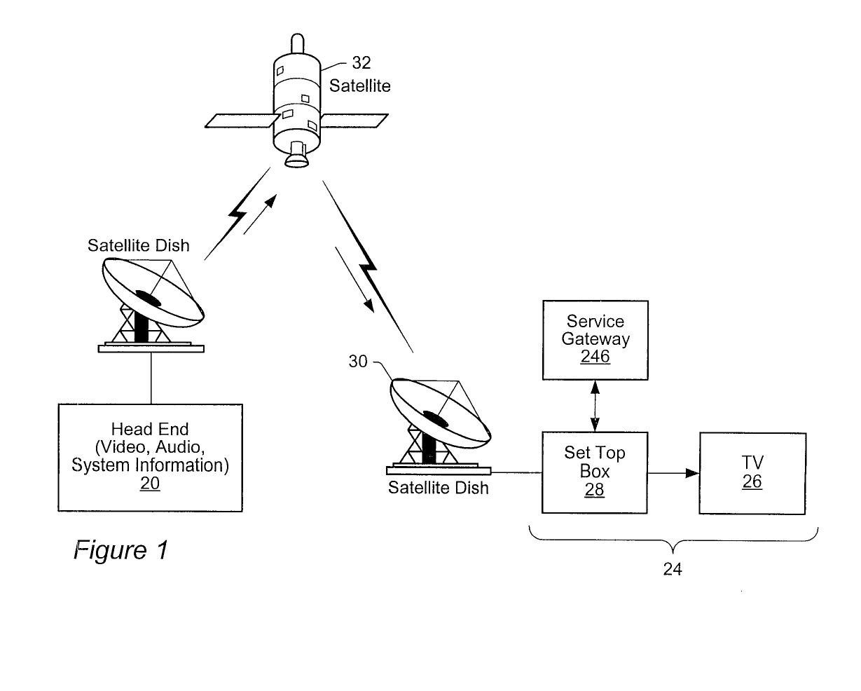

Turning now to FIG. 1, a diagram illustrating one embodiment of an architecture for the transmission or distribution of interactive television applications, television programs (audio and video) and system information (e.g. number of services, service names, event names, event schedules) including the HSPO from a source head-end server to a viewer STB is shown. The HSPO may be transmitted or broadcast once or periodically to the clients. Alternatively, the HSPO may be programmed into the client memory at the manufacturer, downloaded from the Internet, installed via a computer readable medium, or received via a peer-to-peer (PTP) connection or email. The system includes a head-end server 20, which may be coupled with a video and audio device (not shown) that feeds a particular video with associated audio to the head-end. The audio-video-interactive signal contains television programs or similar audio-video content, as well as other signals associated with interactive content such as control signals, system information, HSPO and interactive applications. The video information may be digitized at the head-end 20 and transmitted via a transmitter to a client receiving system 24. The information transmitted by the head-end server 20 is transmitted to the receiving system 24 in various ways. For example, the transmitted information may be sent to the receiving system 24 via a transmitted signal such as a satellite transmission. The receiving station 24 is also be configured to receive signals via a modem channel, cable or terrestrial airwaves. The client receiving system 24 may comprise, for example, a television 26 connected to a set top box 28, a palm computer or a cellular phone (not shown). If satellite transmission is used, the STB 28 may include a receiving antenna 30 for receiving information from a satellite 32. The receiving station antenna 30 passes the interactive television signal to the client (e.g. STB 28), which performs the processing functions of the receiving station 24. Once information is received through the receiving antenna 30, it may be processed by the client (e.g. STB 28) and displayed on the television set 26. In this manner, audio, video, and interactive data may be received and processed by the STB 28. The signals transmitted via the broadcast or modem channels embody various modules which comprise components of an interactive application. The modules contain any type of data such as application code, raw data, or graphical information, for example.

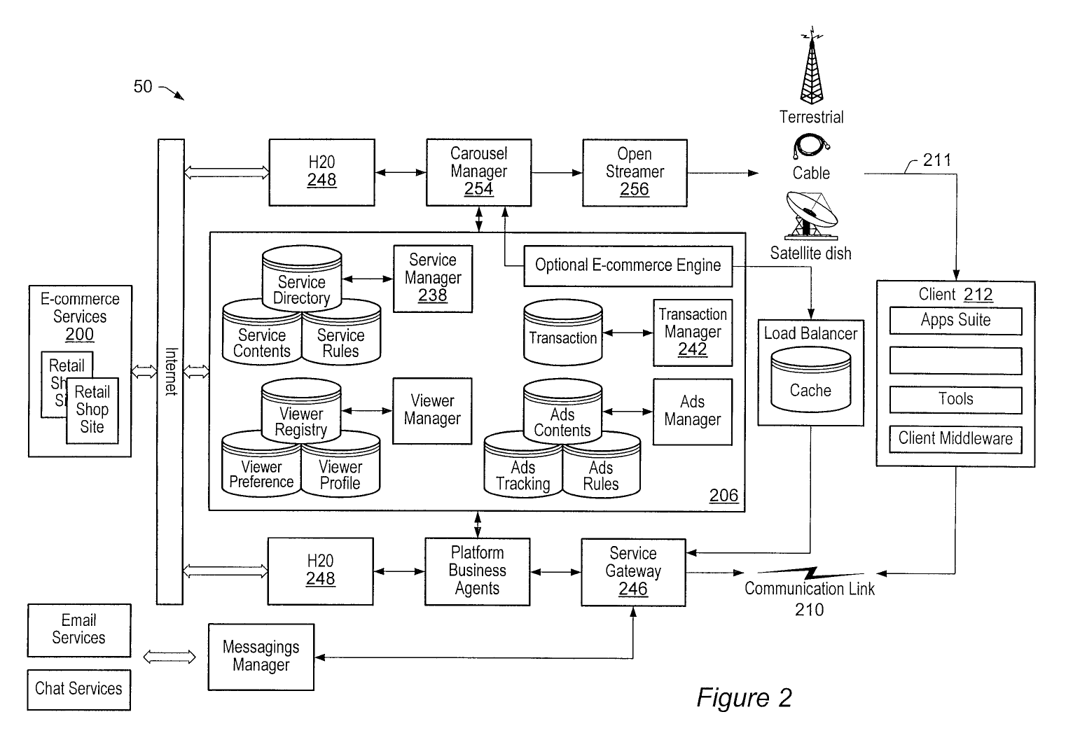

System information provided to the set top box 28 also includes a list of services (e.g. CNN, MTV, ESPN) available to a viewer, event names (e.g. Dateline, Star Trek), and a schedule of the events (e.g. start time/date and duration). The service gateway 246 provides a communication link between the client (e.g. STB 28) and service platform (head-end server) 50 of FIG. 2.

Using a hierarchical security policy object (HSPO) to impose security restrictions or permissions on a receiver client (e.g. STB 28 of FIG. 1) may be useful in any distributed computing system having a server for determining a security policy for one or more client devices. In one embodiment, the distributed computing system comprises an interactive television system, as described below in conjunction with the description of FIG. 2.

Turning now to FIG. 2, an illustration of one embodiment of a head-end server Service Platform (SP) 50 environment from which the policy maker and HSPO may be formulated and broadcast is shown. It is noted however, that the policy maker may alternatively reside in an STB such as STB 28 of FIG. 1. Services 200 may provide shopping, chat, and other services through a communication link such as the internet or other network or communication channels accessible to a network operator. The SP 50 in turn communicates with a client 212 via one or more communication links 211. The client 212 may be a STB, a digital assistant, a cellular phone, or any other communication device capable of communicating with the SP 50 through communication link 210. Using the SP 50, the network operator may access services 200. Business functions 206, comprising service manager 238, interact with carousel manager 254 to retrieve content from a service 200. The carousel comprises a repeating stream of audio/video/interactive data broadcast to clients from the SP 50. Carousel manager 254, transaction manager 242 and service manager 238 control the content insertion and deletion from the broadcast carousel.

In one embodiment, the HSPO creation and policy maker functionality may exist in the service manager 238. In an alternative embodiment, the HSPO policy maker functionality may be located in the client. Service content may be retrieved and converted into a SP suitable format by H2O 248. For example, H2O 248 may be configured to convert HTML content into SP/client readable content. The converted content is formatted into a data carousel and multiplexed by the Open Streamer 256 for broadcast to the client 212. Client 212 interacts with the services and, if necessary and permitted by the HSPO, communicates with the SP 50 and the services 200. Point to Point (PTP) communication between the STB and SP goes through service gateway (SGW) 246.

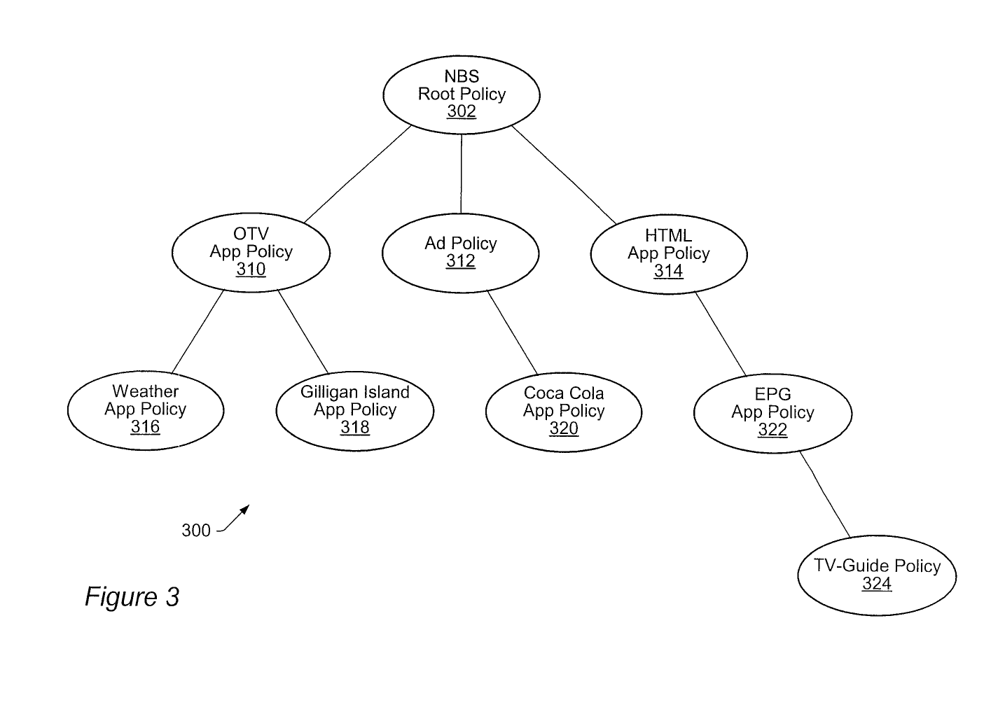

Turning now to FIG. 3, a tree structure diagram of one embodiment a hierarchical security profile object (HSPO) is shown. HSPO 300 may be an HSPO for an exemplary broadcaster network NBS. The head-end formulates the HSPO 300 for NBS and transmits it to all of its viewers/receivers or client/STBs. NBS root policy 302 divides its applications into 3 groups/classes: “OTV App Policy” 310, “Ad Policy” 312, and “HTML App Policy” 314. A fourth class may exist implicitly and by default, and consists of all those applications not included in the other three explicitly defined classes. In the illustrated embodiment of FIG. 3, the “OTV App Policy” 310 class contains entries for two applications, “Weather App policy” 316 and “Gilligan's Island App Policy” 318. The “Ad Policy” 312 class includes a “Coca Cola™ App Policy” 320. The “HTML App Policy” 314 class is further subdivided into Electronic Program Guide (EPG) App Policy 322 under which the broadcaster defines additional special restrictions for the “TV-Guide Policy” 324 application.

Generally speaking, the security policies at the NBS level 302 are to be applied to all members of the same class and subordinate classes. Thus for the NBS network level 302 which would be below the head-end level, the security policy set by the policy maker is defined by NBS. At this level, a high degree of security is imposed. Typically, each group level of application type imposes different security based on the specific desired and selected security requirements for each group. For example, due to their trustworthy nature, applications within the “OTV App Policy” 310 class, which in one embodiment are written in “C” code, are permitted a less restrictive security policy than those within the “Ad Policy” 312 class. This is because the OTV applications come from a trustworthy source and are deemed less risky. Thus, OTV applications may be afforded a more permissive, less restrictive set of security restrictions. Similarly, applications at the same class level may have differing levels of security. For instance, the “Weather App Policy” 316 application might be allowed more capabilities, due to its trustworthy character from a known source, than the “Gilligan's Island App Policy” 318 application, which may originate from a syndicated external source and thus deemed less trustworthy.

In this example, we assume the receiver/client STB already has a copy of the HSPO 300 either previously transmitted from the head-end, downloaded from the internet or programmed into client memory. When the TV station requests that the receiver start up the application associated with, for example, the “Coca Cola™” advertisement, the IRD/receiver must first determine what security restrictions to enforce upon the application. The IRD/receiver takes those restrictions defined by the highest level or “Root” policy 302, for example, “no-lifecycle-control”, adds any additional restrictions defined by the “Ad” policy 312, for example “no-modem-access”, and finally includes restrictions defined specifically for the “Coca Cola™ App policy” 320, for example “no-cookies.” The resulting broadcaster's security policy for the “Coca Cola™” application could, for example, be the union of these policies defined in the HSPO: “no-lifecycle-control, no-modem-access, no-cookies”, that is, the node inherits the security attributes of its class and all preceding nodes in the HSPO tree.

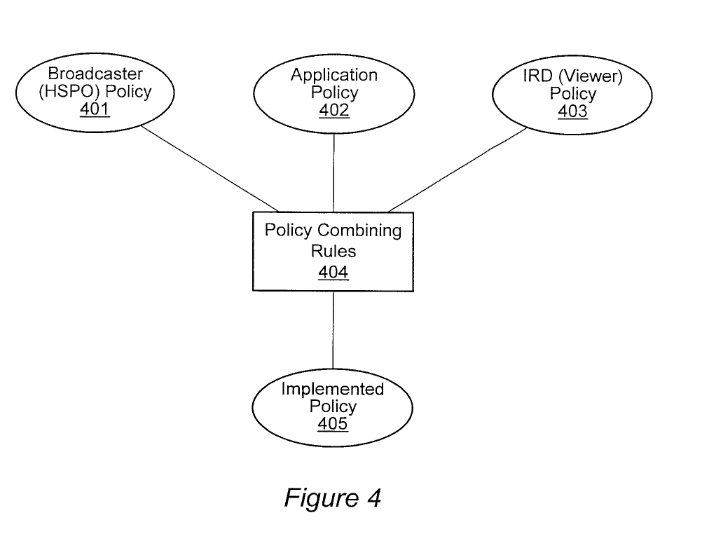

As is shown in FIG. 4, the actual implemented security policy 405 imposed upon any application comprises a combination of inherited characteristics of those defined by the HSPO 401, any policy accompanying the application itself 402, and any policy defined on the IRD (e.g. by the viewer) 403.

Returning to FIG. 3, as a further illustration, the IRD/receiver may compute a security policy applied to an application associated with a “Ford” advertisement similarly. However, although “Ford” is contained in the “Ad Policy” 312 class, there is no “Ford” policy node under the “Ad” node. In this case, the Ford advertisement would only have the broadcaster restrictions specified by the “Root” 302 and “Ad” 312 nodes, namely “no-lifecycle-control, no-modem-access.” Again, these restrictions would then be combined with any access information provided along with the “Ford” advertisement and obtained from the IRD itself to create the resulting policy enforced on the application as described above in conjunction with the description of FIG. 4.

Using the HSPO security restrictions may prevent the necessity of transmitting a set of broadcaster security restrictions along with each broadcast program. The HSPO may be more efficient in that an HSPO need be transmitted only once, or programmed into a client/STB. Thereafter, only exceptions to the established HSPO may need to be transmitted for an application. Once an exception is established in the HSPO, it becomes part of the HSPO tree and need not be transmitted again.

HSPO security restrictions may be useful to prevent programs broadcast or downloaded to a client from a server head-end from performing actions considered risky by that server, such as contracting a virus by interaction with the outside world (i.e. the Internet, email or other programs internal or external to the client (e.g., STB)).

HSPO security restrictions may also disable capabilities or access to memory locations and data, which, may be inadvertently accessed due to programming error. The HSPO may also enable access or deny access to encrypted and/or protected data.

In one embodiment, each level of a HSPO structure may be specified by a different entity. For example, at the top level, a head-end, defines a top-level security restriction, such as “no JAVASCRIPT execution” during a program. In addition, a network (e.g., HBO, NBC, ABC, CBS, ESPN, etc.) may add additional security restrictions to the program, (e.g., no modem access to the next network node level in the HSPO). At the next HSPO node level, a program producer may specify an additional security restriction for the program. At the next level, an advertisement producer can specify an additional security restriction for the program or even a more permissive policy for the program than inherited from the HSPO hierarchical structure and so on.

Depending on the existing HSPO and security policy—a more permissive advertisement policy may or may not be honored. In one embodiment, a lower level security object may override an inherited security restriction from a higher level HSPO node.

It is noted that although the embodiments described above have been described as residing in an interactive television environment, it is contemplated that other embodiments may reside in and/or operate in any distributed computer system including a server and a client device. The client device may be a hand held computer, cell phone, personal digital assistant or any device capable of receiving and/or transmitting an electronic signal. The server may be any device capable of transmitting and/or receiving an electronic signal. Further, the embodiments described above may be implemented as a set of instructions conveyed via a carrier medium such as a broadcast signal, or on a computer readable medium, comprising ROM, RAM, CD ROM, Flash or any other computer readable medium, now known or unknown such that when executed cause a computer to implement the embodiments described above.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for specifying a security policy, said method comprising:
transmitting a hierarchical security program object (HSPO) comprising at least a first class of security attributes;
determining that a first entity corresponds to said class;
determining from the HSPO a set of security attributes for the entity;
assigning the set of security attributes to the entity; and
enforcing the set of security attributes on the entity.

2. The method as recited in claim 1 wherein the HSPO is transmitted from a head-end to a client device.

3. The method as recited in claim 1 wherein said HSPO is downloaded to a client device via a computer network.

4. The method as recited in claim 1 wherein the HSPO is received in a client device, and wherein the method further comprises programming a default HSPO into the client device.

5. The method as recited in claim 1 wherein the HSPO defines a second class of security attributes, said second class being a parent class of the first class, and wherein the set of security attributes comprises a union of the first class of security attributes and the second class of security attributes.

6. The method as recited in claim 5, wherein the first class comprises an advertisement class and the second class comprises a network class.

7. The method as recited in claim 5, wherein the classes are defined by a security policy maker associated with a source of the HSPO.

8. The method as recited in claim 5, wherein the HSPO classes are defined by a security policy maker located in a client device which receives the transmitted HSPO.

9. A computer readable medium comprising program instructions, wherein the program instructions are executable to:
transmit a hierarchical security program object (HSPO) comprising at least a first class of security attributes;
determine that a first entity corresponds to said class;
determine from the HSPO a set of security attributes for the entity;
assign the set of security attributes to the entity; and
enforce the set of security attributes on the entity.

10. The computer readable medium as recited in claim 9, wherein the HSPO is transmitted from a head-end to a client device.

11. The computer readable medium as recited in claim 9, wherein said HSPO is downloaded to a client device via a computer network.

12. The computer readable medium as recited in claim 9, wherein the HSPO is received in a client device, and wherein the program instructions are further executable to program a default HSPO into the client device.

13. The computer readable medium as recited in claim 9, wherein the HSPO defines a second class of security attributes, said second class being a parent class of the first class, and wherein the set of security attributes comprises a union of the first class of security attributes and the second class of security attributes.

14. The computer readable medium as recited in claim 13, wherein the first class comprises an advertisement class and the second class comprises a network class.

15. The computer readable medium as recited in claim 13, wherein the classes are defined by a security policy maker associated with a source of the HSPO.

16. The computer readable medium as recited in claim 13, wherein the HSPO classes are defined by a security policy maker located in a client device which receives the transmitted HSPO.

17. A system comprising:
a server configured to transmit a hierarchical security program object (HSPO) comprising at least a first class of security attributes; and
a client device coupled to receive the HSPO, wherein the client device is configured to:
determine that a first entity corresponds to said class;
determine from the HSPO a set of security attributes for the entity;
assign the set of security attributes to the entity; and
enforce the set of security attributes on the entity.

18. The system as recited in claim 17, wherein said client device includes a storage configured to store a default HSPO.

19. The system as recited in claim 17, wherein the HSPO defines a second class of security attributes, said second class being a parent class of the first class, and wherein the set of security attributes comprises a union of the first class of security attributes and the second class of security attributes.

20. The system as recited in claim 17, wherein the security attributes are defined by a policy maker within either the server or the client device.

21. A device comprising:
a receiver configured to receive a hierarchical security program object (HSPO) comprising at least a first class of security attributes; and
storage configured to store the HSPO;
wherein the device is configured to:
determine that a first entity corresponds to said class;
determine from the HSPO a set of security attributes for the entity;
assign the set of security attributes to the entity; and
enforce the set of security attributes on the entity.

22. The device as recited in claim 21, wherein the HSPO is transmitted from a head-end.

23. The device as recited in claim 21, wherein the HSPO is received via a computer network.

24. The device as recited in claim 21, wherein the HSPO defines a second class of security attributes, said second class being a parent class of the first class, and wherein the set of security attributes comprises a union of the first class of security attributes and the second class of security attributes.

25. The device as recited in claim 24, wherein the first class comprises an advertisement class and the second class comprises a network class.
